(19) United States
(12) Patent Application Publication
(10) Pub. No.: US 2002/0129899 A1
(43) Pub. Date: Sep. 19, 2002

(54) Die pickup method and die pickup apparatus

(75) Inventors: Tsutomu Mimata, Akiruno-shi (JP); Kohei Suzuki, Higashiyamato-shi (JP); Takayuki Taguchi, Oume-shi (JP)

Correspondence Address: KODA & ANDROLIA, Suite 3850, 2029 Century Park East, Los Angeles, CA, 90067-3024, US

(73) Assignee: KABUSHIKI KAISHA SHINKAWA

(21) Appl. No.: 10/095,721

(22) Filed: Mar. 12, 2002

(30) Foreign Application Priority Data
Mar. 13, 2001 (JP) 2001-69919

(51) Int. Cl. B32B 1/00

(52) U.S. Cl. 156/344; 156/584

(57) ABSTRACT

A die pickup method and apparatus that uses a tape peeling stage which supports a portion of an adhesive tape that corresponds to a die to be picked up, and a suction holding stage in which suction holding holes that, with vacuum suction, holds areas of the adhesive tape that surround the die to be picked up, thus separating the die from the adhesive tape by forming an air layer between the die and the adhesive tape, and then picking up the die. The air layer is formed, with the die being held via vacuum suction by a suction nozzle provided above the suction holding stage, by raising the tape peeling stage and then by moving the tape peeling stage horizontally in a direction away from the die.

### BACKGROUND OF THE INVENTION

1. Field of the Invention

The present invention relates to a die pickup method and apparatus that separates dies pasted to an adhesive tape from this adhesive tape and pick up such dies by a suction holding nozzle.

2. Prior Art

A method that uses a push-up needle is generally employed for separating dies from an adhesive tape on which such dies have been pasted. However, this method has a problem. When the thickness of the dies is as small as, for instance, approximately 100 μm or less, the dies are likely damaged.

As a result, methods for separating dies from an adhesive tape without using a push-up needle have been proposed as disclosed in Japanese Patent Application Laid-Open (Kokai) No. H4-148547 (called Example 1) and Japanese Patent Application Laid-Open (Kokai) No. 2000-195877 (called Example 2).

In Example 1, the suction holding surface of the suction holding nozzle in which the suction holding hole that is used to suction-hold the die is formed so that this surface is larger than the upper surface of the die. In addition, sidewalls used for peeling, which cause the peripheral edges of the suction holding surface to protrude beyond the thickness of the die on the die side, are formed on the suction holding surface. As a result, a pellet accommodating space, which has a greater volume than the die and which opens on the die side, is formed by the suction holding surface and side walls used for peeling.

Accordingly, when a die is to be picked up, the suction holding nozzle is lowered so that the die that is to be picked up (which is pasted to the adhesive tape) enters the pellet accommodating space. Then, the suction holding nozzle and adhesive tape are moved relative to each other in a direction parallel to the adhesive tape, and the side surfaces of the die are pushed by the side walls used for peeling, so that the die is moved on the adhesive tape. As a result, the adhesive force is weakened, and the die is suction-held by the suction holding surface.

In Example 2, a plurality of grooves used for vacuum suction, which correspond to the dimensions of the die, are formed in the suction holding state. When a die is to be picked up, the adhesive tape is held via vacuum suction through the grooves, so that the adhesive tape is pulled into the grooves and deformed. The adhesive tape is thus peeled and separated, and then the die is picked up by the suction holding nozzle.

In above-described Example 1, the side surfaces of the die are pushed by the peeling side walls of the suction holding nozzle. Accordingly, there is danger that the die would be damaged by this pressing force. Furthermore, in cases where the thickness of the die is small, the die cannot be reliably pushed, and there is a danger that the peeling side walls of the suction holding nozzle will ride over the upper surface of the die, thus scratching the die.

In Example 2, since no unnecessary force is applied to the die as in Example 1, the problems seen in Example 1 do not arise. However, in Example 2, the adhesive tape is pulled straight below and thus deformed by the application of vacuum suction. Generally, when a bonded die and an adhesive tape are separated, an extremely large force is required if this separation is accomplished by applying a force in the direction perpendicular to the adhesive surface. Accordingly, in cases where the thickness of the die is extremely small, e.g., 50 μm or less, then there is a danger that the die will be deformed and damaged together with the adhesive tape by the suction force of the suction holding stage if the adhesive force is strong. If the adhesive force is weakened, the die would shift in position when the adhesive tape is moved so as to be supplied to the pickup position, etc.

### SUMMARY OF THE INVENTION

Accordingly, the object of the present invention is to provide a die pickup method and pickup apparatus that allows an easy peeling of dies from an adhesive tape without applying any excessive force to dies.

The above object is accomplished by unique steps of the present invention for a die pickup method that, with a use of a suction chucking nozzle, separates a die that is pasted to an adhesive tape from the adhesive tape and picks up the die, wherein the method uses:

a tape peeling stage that supports a portion of the adhesive tape corresponding to a die that is to be picked up, and

a suction holding stage provided with suction holding holes that hold, with vacuum suction, areas of the adhesive tape surrounding the die to be picked up; and

the method includes the steps of:

raising the tape peeling stage or lowering the suction holding stage while the die that is to be picked up is held via vacuum suction by the suction nozzle, and

moving the tape peeling stage horizontally in a direction away from the die to be picked up,

thus causing an air layer to be formed between the die and the adhesive tape, thus separating the die to be picked up from the adhesive tape.

The above object is further accomplished by a unique structure for a die pickup apparatus that, with a suction chucking nozzle, separates a die that is pasted to an adhesive tape from the adhesive tape and picks up the die, and in the present invention, the die pickup apparatus includes:

a tape peeling stage that supports a portion of the adhesive tape corresponding to a die that is to be picked up,

a suction holding stage provided with suction holding holes that hold, with vacuum suction, areas of the adhesive tape surrounding the die to be picked up,

a vertical driving means that raises the tape peeling stage or lowers the suction holding stage, and

a horizontal driving means that moves the tape peeling stage in a direction away from the die to be picked up.

In the above die pickup method and die pickup apparatus, the suction holding holes of the suction holding stage are disposed so as to positionally correspond to three sides of the die to be picked up.

Also, in the horizontal movement of the tape peeling stage, the tape peeling stage is moved so that it positioned underneath a die that is to be picked up next.

Furthermore, the adhesive tape used in the present invention comprises at least a base material, a heat-shrinkable adhesive agent and an ultraviolet-curable adhesive agent, and

In addition, the adhesive tape comprises at least a base material, a heat-shrinkable adhesive agent and an ultraviolet-curable adhesive agent, and a heat treatment is performed beforehand on the adhesive tape so as to heat-shrink the heat-shrinkable adhesive agent and reduce an area of adhesion between the ultraviolet-curable adhesive agent and the die to be picked up.

### BRIEF DESCRIPTION OF THE DRAWINGS

FIG. 1A is a top view of the essential portion of the pickup apparatus according to one embodiment of the present invention, and FIG. 1B is side view thereof shown in cross section;

FIGS. 2A, 2B and 2C are explanatory diagrams that illustrate the die pickup operation in the present invention; and

FIG. 3A is an explanatory front view of a wafer, FIG. 3B is an explanatory front view of the wafer in dicing process, and FIG. 3C is an explanatory front view of a wafer in a state that the heat-shrinkable adhesive agent has been subjected to heat shrinkage.

### DETAILED DESCRIPTION OF THE INVENTION

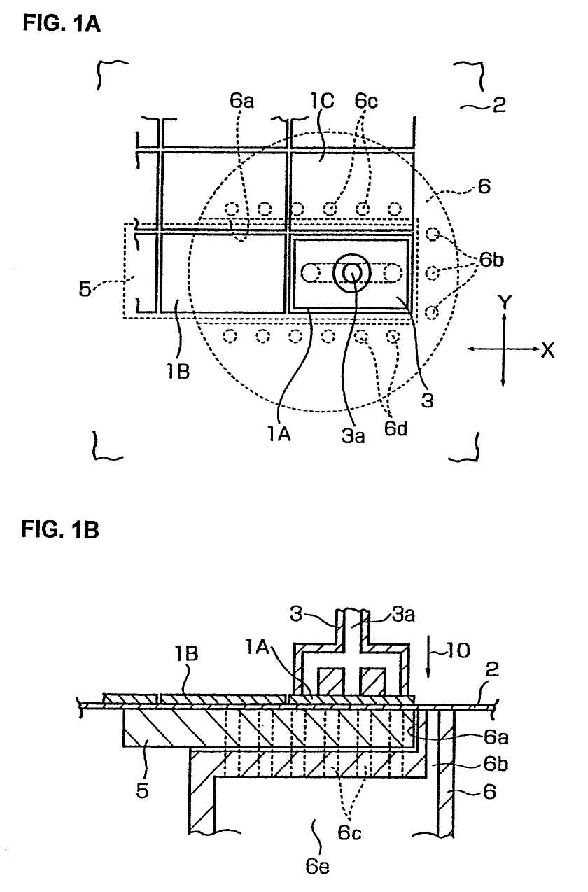

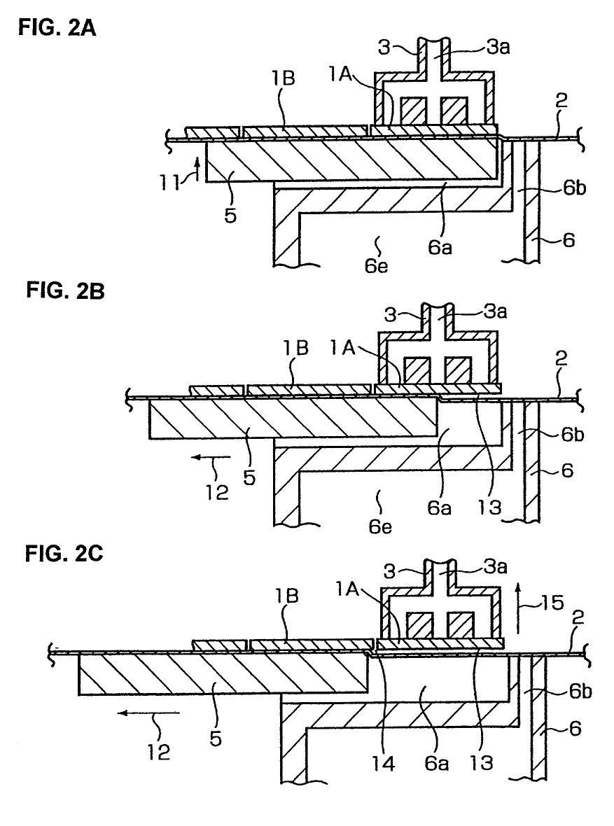

One embodiment of the present invention will be described with reference to FIGS. 1A, 1B, 2A, 2B and 2C.

The outer circumference of an adhesive tape 2 to which dies 1A, 1B . . . are pasted is fastened to a wafer ring (not shown). The wafer ring is fastened to a wafer supporting frame (not shown) which is driven in the directions of the X and Y axes on a horizontal plane. The dies 1A, 1B . . . are held via vacuum suction and picked up by a suction holding nozzle 3 that has a suction holding hole 3a.

The reference numeral 5 is a tape peeling stage 5. The tape peeling stage 5 supports a portion of the adhesive tape 2 that corresponds to die 1A that is to be picked up in the shown embodiment. In other words, the tape peeling stage 5 supports the adhesive tape 2 that is positioned directly under the die 1A. The reference numeral 6 is a suction holding stage 6. The suction holding stage 6 holds by vacuum suction an area of the adhesive tape 2 that surrounds the die 1A that is to be picked up.

A groove 6a that is used to install the tape peeling stage 5 is formed in the suction holding stage 6. In addition, the suction holding stage 6 is provided with suction holding holes 6b, 6c and 6d. The suction holding holes are arranged in a pattern of angled letter C-shape and surround the tape peeling stage 3 on three sides. In other words, the suction holding stage 6 holds, via vacuum suction and by means of suction holding holes 6b, 6c and 6d, the areas of the adhesive tape 2 that correspond to three sides of the die 1A that is to be picked up. More specifically, the suction holding stage 6 suction-holds the adhesive tape 2 that is not directly under the die 1A. The suction holding holes 6b, 6c and 6d are communicated with a suction holding hole 6e, and the suction holding hole 6e is communicated with a vacuum source (not shown).

The tape peeling stage 5 is movable by a horizontal driving means (not shown) along the groove 6a of the suction holding stage 6 so that it is moved horizontally in the horizontal movement direction 12 and in the direction opposite from the direction 12. The tape peeling stage 5 is also movable in vertical direction so that it is raised in the upward direction 11 and lowered in the opposite direction by a vertical driving means (not shown).

Next, the operation of the above described pickup apparatus will be described below in detail.

In FIG. 1A, the suction holding nozzle 3 is above the pickup position. The tape peeling stage 5 is inside the groove 6a of the suction holding stage 6. In this state, the adhesive tape 2 fastened to a wafer ring (not shown) is caused to move in the directions of the X and Y axes by an XY-axis driving means (not shown), so that the die 1A that is to be picked up is positioned in the pickup position.

Next, as shown in FIG. 1B, the area of the adhesive tape 2 that surrounds the periphery of the die 1A that is to be picked up is held via vacuum suction by the suction holding stage 6 through the suction holding holes 6b, 6c and 6d. At the same time as this vacuum suction, the suction holding nozzle 3 is lowered as shown by arrow 10, and the die 1A is held via vacuum suction by the suction holding hole 3a of the suction holding nozzle 3.

Next, as seen from FIG. 2A, the tape peeling stage 5 is raised as shown by arrow 11 several millimeters by the vertical driving means (not shown). The die 1A is thus raised together with the suction holding nozzle 3. As a result, the area of the adhesive tape 2 that surrounds the periphery of the die 1A is stretched by an amount that corresponds to the amount of rise of the tape peeling stage 5 as shown by arrow 11, and tensile stress is applied to the adhesive tape 2.

Then, the tape peeling stage 5 is moved horizontally as indicated by arrow 12 by the horizontal driving means (not shown) as shown in FIG. 2B until the stage 5 is moved to the position shown in FIG. 2C where the peeling stage 5 is no longer under the die 1A and under the die 1B that is to be picked up next. When the tape peeling stage 5 is moved horizontally in the direction of arrow 12, the groove 6a is enlarged as seen in FIG. 2B, and an air layer 13 is formed between the die 1A and the adhesive tape 2. This air layer 13 is formed because the tape 2 on which the tensile stress has been applied relieves such tensile stress when the tape peeling stage 5 is moved away from underneath the die 1A, and the adhesive tape 2 returns to its original position, thus forming a space (air layer) between the die 1A and the adhesive tape 2.

As shown in FIG. 2C, when the tape peeling stage 5 is moved horizontally as far as a point located beneath the die 1B that is to be picked up next, the die 1A is completely separated from the adhesive tape 2. As a result, the die 1A held via vacuum suction by the suction holding nozzle 3 is picked up by the suction holding nozzle 3.

The suction holding nozzle 3 that holds the die 1A via vacuum suction is raised as shown by arrow 15 and moved in the directions of the X and Y axes by a feeding means (not shown), so that next process such as die bonding, die packing, etc. is performed.

When the die 1A picked up and raised by the suction holding nozzle 3 as described above, the tape peeling stage 5 is moved in the opposite direction from the directions indicated by arrows 11 and 12 (in other words, it is lowered and moved to the right in FIG. 2C) and returns to the initial position shown in FIG. 1A. The wafer ring (not shown) to which the adhesive tape 2 is fastened is moved in X and Y directions so that the die 1B that is to be picked up next is positioned in the pickup position above the suction holding stage 6. Then, the process described above is repeated.

As seen from the above, by raising the tape peeling stage 5 in the direction of arrow 11, the adhesive tape 2 around the periphery of the die 1A that is to be picked up is stretched; and by causing the tape peeling stage 5 to make a horizontal movement in the direction of arrow 12 or in the direction opposite from the die 1A, the air layer 13 is formed between the die 1A and the adhesive tape 2, thus causing the die 1A to be separated from the adhesive tape 2. In this process, no excessive force is applied to the die 1A. Accordingly, there is no damage occurs to the die 1A. Furthermore, in the above process, peeling is accomplished by forming the air layer 13 between the die 1A and the adhesive tape 2 and thus not accomplished by pulling the adhesive tape 2 downward by suction as in the conventional method. Accordingly, the die 1A can easily be peeled from the adhesive tape 2.

Furthermore, as seen from FIG. 2C, by way of moving the tape peeling stage 5 horizontally in the direction of arrow 12 as far as to a point located beneath the die 1B that is to be picked up next, another air layer 14 is formed around the periphery of the die 1B. Accordingly, peeling of next die 1B can be made easier.

In the above embodiment, the tape peeling stage 5 is raised in the direction of arrow 11 in order to achieve the transition from the state shown in FIG. 1B to the state shown in FIG. 2A. However, it is also possible to lower the suction holding stage 6 instead of raising the tape peeling stage 5 for obtaining the same effect.

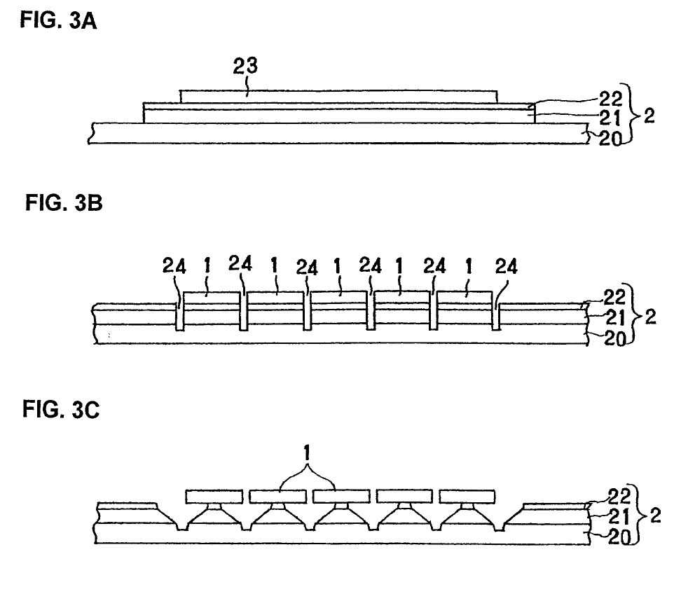

In the present invention, there are no particular restrictions on the material of the adhesive tape 2. For instance, the tape 2 may have a structure that includes as shown in FIG. 3A a base material 20 consisting of a polyethylene film, a heat-shrinkable adhesive agent 21 disposed on this base material 20 and an ultraviolet-curable adhesive agent 22 disposed on this heat-shrinkable adhesive agent 21. With this tape 2, peeling of the die 1 from the tape 2 is facilitated.

When the tap 2 shown in FIG. 3A is used, a wafer 23 is fastened to the ultraviolet-curable adhesive agent 22 of the adhesive tape 2. Furthermore, as shown in FIG. 3B, dicing grooves 24 are formed by dicing the wafer 23 pasted to the ultraviolet-curable adhesive agent 22, so that individually separated dies 1 are formed in rows in the directions of the X and Y axes on the horizontal plane.

Japanese Patent No. 3073239 may be cited as an example that discloses the adhesive tape 2 used in the present invention.

As seen from FIG. 3C, in the present invention, the adhesive force of the ultraviolet-curable adhesive agent 22 is weakened by irradiating ultraviolet light, etc. before the die 1 is picked up; and a heat treatment can be also performed so as to heat-shrink the heat-shrinkable adhesive agent 21 that corresponds to the die that is to be picked up, thus reducing the area of adhesion of the ultraviolet-curable adhesive agent 22 to the die 1. With such treatments, since the contact area between the die 1 and the ultraviolet curable adhesive agent 22 is reduce and the air layer 13 can be more easily formed, the peeling of the die 1 can be facilitated even further.

In the present invention, it is also effective to perform, prior to die pickup, an ultraviolet irradiation treatment so as to weaken the adhesive force of the ultraviolet-curable adhesive agent 22 without performing heat treatment that causes heat shrinkage of the heat-shrinkable adhesive agent 21 that corresponds to a die to be picked up, in other words, without reducing the area of adhesion of the ultraviolet-curable adhesive agent 22 to the die. It is further effective to perform, prior to die pickup, only a heat treatment that reduces the area of adhesion of the ultraviolet-curable adhesive agent 22 to the die 1 by way of heat-shrinking the heat-shrinkable adhesive agent 21 that corresponds to the die to be picked up.

Thus, it goes without saying that in the present invention the ultraviolet light irradiation treatment and heat treatment can be performed singly or in combination, and the extent of such treatment or treatments can be increased or decreased.

As seen from the above, according to the present invention, a tape peeling stage, which supports a portion of the adhesive tape that corresponds to a die that is to be picked up, and a suction holding stage, in which suction holding holes that holds with a use of vacuum suction the areas of the adhesive tape that surround the die to be picked up, are used; and the tape peeling stage is raised or the suction holding stage is lowered with the die to be picked up being held via vacuum suction by the suction nozzle, and then the tape peeling stage is moved horizontally in a direction away from the die, thus forming an air layer between the die, allowing the die to be separated from the adhesive tape, and then the die is picked up. Accordingly, dies can easily be separated from an adhesive tape without being applied with excessive forces.

1. A die pickup method that, with a suction holding nozzle, removes a die that is pasted to an adhesive tape from said adhesive tape and picks up said die, wherein
with a use of:
a tape peeling stage that supports a portion of said adhesive tape, said portion corresponding to a die that is to be picked up, and
a suction holding stage provided with suction holding holes that hold, with vacuum suction, an area of said adhesive tape, said area surrounding said die to be picked up,
said method comprises the steps of:
raising said tape peeling stage or lowering said suction holding stage with said die to be picked up being held via vacuum suction by said suction nozzle, and moving said tape peeling stage horizontally in a direction away from said die to be picked up,
thus causing an air layer to be formed between said die and said adhesive tape and separating said die to be picked up from said adhesive tape, and
picking up said die to be picked up by said suction nozzle.

2. A die pickup apparatus that, with a suction holding nozzle, removes a die that is pasted to an adhesive tape from said adhesive tape and picks up said die, said apparatus comprising:
a tape peeling stage that supports a portion of said adhesive tape, said portion corresponding to a die that is to be picked up, and
a suction holding stage provided with suction holding holes that hold, with vacuum suction, an area of said adhesive tape, said area surrounding said die to be picked up,
a vertical driving means that raises said tape peeling stage or lowers said suction holding stage, and
a horizontal driving means that moves said tape peeling stage in a direction away from said die to be picked up.

3. The die pickup method according to claim 1, wherein said suction holding holes of said suction holding stage are disposed so as to positionally correspond to three sides of said die to be picked up.

4. The die pickup apparatus according to claim 2, wherein said suction holding holes of said suction holding stage are disposed so as to positionally correspond to three sides of said die to be picked up.

5. The die pickup method according to claim 1, wherein in a horizontal movement of said tape peeling stage, said tape peeling stage is moved to beneath a die that is to be picked up next.

6. The die pickup apparatus according to claim 2, wherein in a horizontal movement of said tape peeling stage, said tape peeling stage is moved to beneath a die that is to be picked up next.

7. The die pickup method according to claim 1, wherein
said adhesive tape comprises at least a base material, a heat-shrinkable adhesive agent and an ultraviolet-curable adhesive agent, and
an adhesive strength of said ultraviolet-curable adhesive agent is weakened before said die to be picked up is picked up.

8. The die pickup apparatus according to claim 2, wherein
said adhesive tape comprises at least a base material, a heat-shrinkable adhesive agent and an ultraviolet-curable adhesive agent, and
an adhesive strength of said ultraviolet-curable adhesive agent is weakened before said die to be picked up is picked up.

9. The die pickup method according to claim 1, wherein
said adhesive tape comprises at least a base material, a heat-shrinkable adhesive agent and an ultraviolet-curable adhesive agent, and
a heat treatment is performed beforehand on said adhesive tape so as to heat-shrink said heat-shrinkable adhesive agent and reduce an area of adhesion between said ultraviolet-curable adhesive agent and said die to be picked up.

10. The die pickup apparatus according to claim 2, wherein
said adhesive tape comprises at least a base material, a heat-shrinkable adhesive agent and an ultraviolet-curable adhesive agent, and
a heat treatment is performed beforehand on said adhesive tape so as to heat-shrink said heat-shrinkable adhesive agent and reduce an area of adhesion between said ultraviolet-curable adhesive agent and said die to be picked up.

11. The die pickup method according to claim 7, wherein said adhesive strength of said ultraviolet-curable adhesive agent is weakened by way of applying ultraviolet light to said ultraviolet-curable adhesive agent.

12. The die pickup apparatus according to claim 8, wherein said adhesive strength of said ultraviolet-curable adhesive agent is weakened by way of applying ultraviolet light to said ultraviolet-curable adhesive agent.
